(19) United States
(12) Patent Application Publication
(10) Pub. No.: US 2021/0373946 A1
(43) Pub. Date: Dec. 2, 2021

(54) METHOD FOR SCHEDULING OF SERVICE PROCESSES IN HYBRID CLOUD

(71) Applicant: SOOCHOW UNIVERSITY, Suzhou (CN)

(72) Inventors: Helan LIANG, Suzhou (CN); Fanzhang LI, Suzhou (CN); Bangjun WANG, Suzhou (CN)

(21) Appl. No.: 17/255,401

(22) PCT Filed: Nov. 22, 2019
(86) PCT No.: PCT/CN2019/120130

§ 371 Date: Dec. 22, 2020

(30) Foreign Application Priority Data
Sep. 23, 2019 (CN) 201910899070.8

(51) Int. Cl. G06F 9/48; G06F 9/50; G06F 9/455

(52) U.S. Cl. CPC G06F 9/4881; G06F 9/5077; G06F 2009/45595; G06F 2009/45562; G06F 9/45558

(57) ABSTRACT

The present invention discloses a method for scheduling of service processes in hybrid cloud considering virtual machine deployment and an interval-based charging mode. The method includes: acquiring a task set TS, a hybrid cloud CPS, a physical machine set PMS, a periodic charging mode TCM, a maximum number of iterations Maxᵢₜₑᵣ, a group population Gₚₒₚ, a maximum generation number E of sparks, a maximum explosion amplitude R, an initial temperature T, and a cooling rate cr; in an initial phase, first generating an initial firework population; performing random encoding on each firework into a real number list, represented by a priority list of tasks; decoding each firework into a complete scheduling solution and calculating an objective value of the solution; and in an iteration phase, continuously updating the firework, and outputting the best solution once a stop condition is satisfied.

### FIELD OF THE INVENTION

The present invention relates to the field of cloud services, and specifically, to a method for scheduling of service processes in hybrid cloud considering virtual machine deployment and an interval-based charging mode.

### DESCRIPTION OF THE RELATED ART

Cloud computing is a novel service mode that implements service invocation based on a virtualization technology and an on-demand mode. Cloud computing specifically includes a public cloud mode, a private cloud mode, and a hybrid cloud mode. For various middle-scale and small-scale enterprises, the use of a single public cloud platform contributes to a lower cost of infrastructure construction, but it is difficult to ensure the security of data. In contrast, if an enterprise only uses a private cloud, it is usually difficult to bear huge costs of the infrastructure construction and routine maintenance. The hybrid cloud mode helps to fully utilize existing resources of an enterprise and guarantee the security of confidential data, has the advantage of the flexible extensibility of public cloud resources, and is therefore gaining increasing attention in business and academic circles.

With the growing diversity and complexity of service requirements, service processes become increasingly complex and have increasingly high computing requirements. To satisfy service processes execution requirements of enterprises, it is essential to appropriately arrange the execution resources and execution time for tasks in the service processes. Especially, from the perspective of a user, cost minimization is a very important objective. Therefore, how to schedule the service processes in hybrid cloud to achieve cost minimization is a current hot research topic.

At present, many scholars have carried out considerable researches on the problem of scheduling of service processes in hybrid cloud and have attained abundant research results. However, the types and the number of virtual machines need to be defined in most of the models above. However, by using a virtualization technology, one physical machine may be instantiated into various virtual machines with different configurations. Therefore, if a method for predetermining the number of virtual machines, the flexibility of cloud computing is reduced. In addition, some scholars restrict the types of virtual machines and build virtual resource pool constraints, to ensure that a resource requirement of virtual machines cannot exceed an upper resource limit of a hybrid cloud. However, whether a virtual machine can be successfully created depends on the capacity of a physical machine. Therefore, this method may lead to an unfeasible solution. To provide a feasible scheduling solution in a hybrid cloud, a virtual machine to which a task is to be allocated needs to be considered, and if the virtual machine is run in a private cloud, a physical machine on which the virtual machine is to be deployed further needs to be considered.

In another aspect, a cloud provider usually performs charging by using an interval-based charging mode. For example, Amazon sets one hour as a charging period, and as the use time increases, a larger discount is offered. In recent years, in many researches, the execution time of each task is only calculated according to an integer multiple of a charging period but the idle time between tasks is not utilized. In addition, discounts are not considered. Therefore, it is difficult to achieve cost optimization. For precise computing and cost reduction, periodic charging and discounts need to be jointly considered, resulting in a more complex scheduling problem.

For the problem of scheduling a hybrid cloud service processes, some researches provide a heuristic method. If a private cloud cannot complete a corresponding task before the deadline, the task is allocated to a public cloud. However, it is assumed that the types and the number of virtual machines are known in all the foregoing researches. Because a physical resource in a cloud may be flexibly instantiated into different types of virtual machines. Therefore, if the types and the number of virtual machines are fixed, a search space is narrowed down, and it is less likely to find an adequate solution. To resolve the foregoing problem, a virtual resource pool constraint is established in some researches. In these researches, only the types of virtual machines are defined, but the specific number of virtual machines is not fixed. In addition, it is specified that resources required for virtual machines in a private cloud cannot exceed the total number of resources (for example, the total number of CPUs in the private cloud). However, because whether a virtual machine can be created depends on the capacity of a single physical machine, the foregoing method causes an excessively large search space, leading to a lot of unfeasible solutions. To precisely define a search space, it is inevitable to consider the problem of virtual machine deployment in a private cloud, to ensure that a scheduling plan can satisfy a resource constraint of the private cloud.

To resolve the problem of virtual machine deployment, some research scholars have established models and resolve how to allocate a group of virtual machines to physical machines. However, it is assumed that the types, the number, and the scheduling time of virtual machines are prior known in all the foregoing researches. In contrast, in the problem of cloud scheduling, the types and the number of virtual machines are unknown. Therefore, the foregoing methods cannot be used to resolve the problem of cloud scheduling. For the problems of virtual machine deployment and the matching between a task and a virtual machine, the latest literature provides a heuristic task scheduling algorithm. The research provides five scheduling rules. A feasible virtual machine configuration may be obtained, and a task is allocated to an appropriate virtual machine. However, only independent tasks rather than service processes is considered in the research. In addition, only a single cloud environment is considered in the research. That is, once a resource requirement of a task exceeds the capability of a physical machine in a private cloud, the task is rejected. Therefore, the research cannot be used for processing the problem of scheduling of service processes in hybrid cloud.

Existing cloud providers usually use an interval-based charging mode to perform charging. However, it is assumed that the types and the number of virtual machines are known or only a public cloud environment is considered in all the foregoing researches. In contrast, a hybrid cloud environment includes both a private cloud with limited resources and a public cloud that can provide virtual machines of any type and any number. Therefore, the foregoing research is hardly applicable. In addition, many cloud providers usually design a discount-based charging mode to attract users. As the use time of a user increases, a larger discount is offered. However, a discount model is not considered in the current researches. Therefore, it is difficult to precisely calculate costs in the researches, and how to appropriately increase the duration of continuous use of resources to reduce costs is not considered.

Conventional technologies have the following technical problems:

(1) During the building of a problem model, the types and the number of virtual machines need to be known in various researches, and it is less likely to find a better solution. A method for establishing a resource pool constraint may cause an excessively large search space, leading to a lot of unfeasible solutions. To precisely describe the problem of scheduling of service processes in hybrid cloud, virtual machine deployment in a private cloud should further be considered in a more detailed manner, to ensure that configured virtual machines can satisfy a physical machine resource constraint of the private cloud.

(2) A periodic charging mode and a continuous use discount model used by a current cloud provider are not fully considered in combination with an actual case. As a result, it is difficult to precisely calculate an execution cost of the service processes. In addition, how to appropriately increase the duration of continuous use of resources to reduce costs is not considered.

### SUMMARY OF THE INVENTION

A technical problem to be resolved by the present invention is to provide a method for scheduling of service processes in hybrid cloud considering virtual machine deployment and an interval-based charging mode, to establish a more practical problem model for the problem of scheduling of service processes in hybrid cloud. The model establishes a more precise formal model for resource constraints in a hybrid cloud, to accurately define a search space. In addition, a charging mode including a charging period and a continuous use discount is considered, to help to accurately calculate a cost and appropriately utilize resources to reduce the cost. An improved firework algorithm is provided. In view of the characteristics of problems such as dependence relationships among tasks, virtual machine deployment, and periodic charging in service processes, the algorithm provides specific firework encoding representation, decoding, and a firework update strategy based on the Metropolis criterion, to help to improve the computing effectiveness and efficiency.

To resolve the foregoing technical problem, the present invention provides a method for scheduling of service processes in hybrid cloud considering virtual machine deployment and an interval-based charging mode, including:

acquiring a task set TS, a hybrid cloud CPS, a physical machine set PMS, a periodic charging mode TCM, a maximum number of iterations Maxᵢₜₑᵣ, a group population Gₚₒₚ, a maximum generation number E of sparks, a maximum explosion amplitude R, an initial temperature T, and a cooling rate cr;

in an initial phase, first generating an initial firework population;

first performing random encoding on each firework into a real number list, represented by a priority list of tasks; decoding each firework into a complete scheduling solution, and calculating an objective value of the solution; and in an iteration phase, continuously updating the firework, and outputting the best solution once a stop condition is satisfied,

where a scheduling result satisfies:

$$\begin{matrix}ck = {arg min}_{i \leq \vert BL \vert , {be}_{i} - ( {BIE}_{kq}^{v} - {BIS}_{kq}^{v} ) \geq 0} \{ {be}_{i} - ( {BEI}_{kq}^{v} - {BSI}_{kq}^{v} ) \} ; and & ( 1 ) \\ cos {t}_{kq}^{v} = {\sum }_{i = 0}^{ck - 1} {\int }_{{bs}_{i}}^{{be}_{i}} {f}_{i} ( t ) dt + {\int }_{{bs}_{ck}}^{{BEI}_{kq}^{v} - {BSI}_{kq}^{v}} {f}_{ck} ( t ) dt , & ( 2 )\end{matrix}$$

in Formula (1), charging duration BIE_{kq}^{v}-BIS_{kq}^{v} is calculated and is then compared with an end time beᵢ of each part, to obtain the number ck of covered charging intervals; in Formula (2), the cost of each covered interval may be calculated, and finally summation is performed to obtain a total cost;

$$\begin{matrix}min TC = {\sum }_{{cp}_{k} ∈ CPS} {\sum }_{{vmt}_{k}^{v} ∈ {VMT}_{k}} {\sum }_{q = 1}^{\vert {BIZ}_{k}^{v} \vert} cos {t}_{kq}^{v} ; & ( 3 ) \\ st . {sa}_{ij} \geq max \{ {sa}_{iu} + {g}_{iu} \vert {t}_{iu} \to {t}_{ij} \} , ∀ {t}_{ij} , {t}_{iu} ∈ TS ; & ( 4 ) \\ max \{ {sa}_{ij} + {g}_{ij} \vert {t}_{ij} ∈ TS \} \leq dt ; & ( 5 ) \\ ( {BIE}_{kq}^{v} - {BIS}_{kq}^{v} ) mod ( {bc}_{k}^{v} ) = 0 , ∀ {cp}_{k} ∈ CPS ; {vmt}_{k}^{v} ∈ {VMT}_{k} ; q = 1 , … , \vert {BIZ}_{k}^{v} \vert ; & ( 6 ) \\ {\sum }_{{cp}_{k} ∈ CPS} {\sum }_{{vmt}_{k}^{v} ∈ {VMT}_{k}} {\sum }_{q = 1}^{\vert {BIZ}_{k}^{v} \vert} {x}_{ij}^{kvq} = 1 , ∀ {t}_{ij} ∈ TS ; & ( 7 ) \\ {zv}_{kvq}^{s} \geq {\sum }_{{t}_{ij} ∈ TS} {zt}_{ij}^{s} \times {x}_{ij}^{kvq} , ∀ {cp}_{k} ∈ CPS ; {vmt}_{k}^{v} ∈ {VMT}_{k} ; s = 1 , … , ∞ ; & ( 8 ) \\ {\sum }_{{vmt}_{1}^{v} ∈ {VMT}_{1}} {\sum }_{q = 1}^{\vert {BIZ}_{1}^{v} \vert} {ρ}_{p} \times {y}_{vq}^{p} \times {zv}_{1 vq}^{s} \times {vcpu}_{v} \leq {C}_{p}^{cpu} , ∀ s = 1 , … , ∞ ; {pm}_{p} ∈ PMS ; & ( 10 ) \\ {\sum }_{{vmt}_{1}^{v} ∈ {VMT}_{1}} {\sum }_{q = 1}^{\vert {BIZ}_{1}^{v} \vert} {y}_{vq}^{p} \times {zv}_{1 vq}^{s} \times {vmem}_{v} \leq {C}_{p}^{mem} , ∀ s = 1 , … , ∞ ; {pm}_{p} ∈ PMS ; & ( 11 ) \\ {zt}_{ij}^{s} = \{ \begin{matrix}1 & if s ∈ [ {sa}_{ij} , {sa}_{ij} + {g}_{ij} ] \\ , & \\ 0 & otherwise ;\end{matrix} & ( 12 ) \\ {zv}_{kvq}^{s} = \{ \begin{matrix}1 & if s ∈ [ {BSI}_{kq}^{v} , {BEI}_{kq}^{q} ] \\ , & \\ 0 & otherwise ;\end{matrix} & ( 13 ) \\ {x}_{ij}^{kvq} ∈ \{ 0 , 1 \} , ∀ {t}_{ij} ∈ TS ; {cp}_{k} ∈ CPS ; {vmt}_{k}^{v} ∈ {VMT}_{k} ; q = 1 , … , \vert {BIZ}_{k}^{v} \vert ; and & ( 14 ) \\ {y}_{vq}^{p} ∈ \{ 0 , 1 \} , ∀ {t}_{ij} ∈ TS ; {pm}_{p} ∈ PMS ; {vmt}_{1}^{v} ∈ {VMT}_{1} ; q = 1 , … , \vert {BIZ}_{1}^{v} \vert , & ( 15 )\end{matrix}$$

wherein objective (3) is to minimize the total cost for a user; constraints (4) and (5) the dependence relationships of tasks and the deadline constraint of the service processes; constraint (6) indicates that charging duration of a virtual machine is an integer multiple of a charging period; constraint (7) represents that each task needs to be allocated to one virtual machine; constraint (8) indicates that only one task can be run at one time on each virtual machine; constraint (9) ensures that each virtual machine provided on a private cloud needs to be deployed on one physical machine; constraints (10) and (11) ensure that CPU and memory requirements of each virtual machine provided on the private cloud do not exceed an available resource limitation of a physical machine deployed on the private cloud; and Formulas (12) to (15) provide the definitions of decision variables.

| Symbol | Explanation |
|---|---|
| xᵢⱼ^{kvq} | Binary variable, where xᵢⱼ^{kvq} = 1 represents that a task tᵢⱼ is |
| | allocated to an instance q of a virtual machine type v provided |
| | by a cloud provider cpₖ; |
| y_{vq}^{p} | Binary variable, where y_{vq}^{p} = 1 represents that the instance q |
| | of the virtual machine type v provided by a private cloud |
| | is deployed on a physical machine p; |
| ztᵢⱼ^{s} | Binary variable, where ztᵢⱼ^{s} = 1 represents that the task tᵢⱼ is |
| | being run at a moment s; |
| zv_{kvq}^{s} | Binary variable, where zv_{kvq}^{s} = 1 represents that the instance q |
| | of the virtual machine type v of the cloud provider cpₖ is being |
| | run at the moment s; |
| vcpuᵥ | Number of CPUs required for the virtual machine type v of the |
| | private cloud; |
| vmemᵥ | Size of memory required for the virtual machine type v of the |
| | private cloud; |
| Cₚ^{cpu} | Number of CPUs provided by the physical machine p in the |
| | private cloud; |
| Cₚ^{mem} | Size of memory provided by the physical machine p in the |
| | private cloud; |
| saᵢⱼ | Start time of the task tᵢⱼ; |
| gᵢⱼ | Expected running time required for the task tᵢⱼ; |
| dt | Deadline of the service processes; |
| bcₖ^{v} | Charging cycle of the virtual machine type v of the cloud |
| | provider cpₖ; |
| ρₚ | Applied decrease rate for the CPU requirement of the physical |
| | machine p; |
| BIZₖ^{v} | Charging duration set of the virtual machine type v provided by |
| | the cloud provider cpₖ, because each virtual machine type may |
| | subscribe to a plurality of instances, BIZₖ^{v} = {[BISₖ₁^{v}, BIEₖ₁^{v}], |
| | [BISₖ₂^{v}, BIEₖ₂^{v}], . . .}, where BIS_{kq}^{v} and BIE_{kq}^{v} respectively |
| | represent a start time and an end time of the instance q; |
| VMT | A group of virtual machine types provided by the cloud provider |
| | cpₖ; |
| CPS | Hybrid cloud, where cp₁ is the private cloud, and ExCs = |
| | {cp₂, . . . , cpₙ} is a public cloud set; |
| TS | Task set; |
| PMS | Physical machine set of the private cloud; |
| BL | Number of price intervals; |
| bsⱼ | Start time of a j^{th} price interval; |
| Beⱼ | End time of the j^{th} price interval; |
| fⱼ(t) | Pricing function of the j^{th} price interval; |
| ck | Number of price intervals covered by a subscription time of a |
| | virtual machine; |
| cost_{kq}^{v} | Subscription cost of a q^{th} virtual machine of the type v of the |
| | cloud provider cpₖ; |
| TC | Total subscription cost; |

In one of the embodiments, the priority list of tasks is represented by using a first method, and the first method is specifically as follows:

firework encoding is usually defined as a real number list, but an encoding scheme of the real number list cannot be directly used for a scheduling problem; the real number list may further be converted into the priority list of tasks according to an ROV rule, where a task with a relatively low priority is first allocated to a resource; however, the foregoing method is only applicable to an independent task; a method for representing firework encoding considering a task dependence relationship (an algorithm 1) is provided herein based on current researches; in the algorithm, one task is allocated to each position in an encoding list by using Formula (16); as shown in Formula (16), in the algorithm, it is relatively more likely to select a task with the highest priority, or a task is selected at a low probability based on roulette wheel selection, to improve diversity; and in addition, a task needs to be chosen before a subsequent task of the task can be considered, to ensure that the priority of each task is definitely lower than a preceding task of the task;

$${t}_{ij} ( k ) = \{ \begin{matrix}{arg max}_{{t}_{ij} ∈ STP} \{ {fw}_{ij} \} , & if rand ( 0 , 1 ) \leq {p}_{0} \\ Rou ( \frac{{fw}_{ij}}{{\sum }_{{t}_{ij} ∈ STP} {fw}_{ij}} ) , & otherwise ,\end{matrix} \qquad ( 16 )$$

where tᵢⱼ(k) is a task allocated to a k^{th} position; STP is a set of arrangeable tasks; fwᵢⱼ is a real number value corresponding to a task tᵢⱼ in firework encoding; p₀ is a preset threshold; rand(0, 1) is a decimal randomly generated in the interval (0, 1); and Rou(·) represents a roulette selection strategy.

In one of the embodiments, each firework is decoded into a complete scheduling solution by using a second method, and the second method is specifically as follows: to avoid the traversal of all virtual machines and increase the interval of continuous use, three resource priority principles are designed: 1. a principle of assigning a priority to a virtual machine to which a preceding task is allocated: in this case, because a virtual machine may continue to execute a current task and there is no idle wait time between tasks, an idle time caused by periodic charging can be fully utilized and the time of continuous use can be increased; 2. if the first case is not satisfied, a search interval is extended to all virtual machines to which a task has been allocated previously, and the case helps to increase the duration of continuous use of an existing virtual machine; and 3. if neither of the foregoing two cases is satisfied, all newly created virtual machine instances are considered, to ensure that a task is allocated to a feasible virtual machine.

In addition, after tasks are all arranged on virtual machines, a scheduling cost further needs to be calculated; in the method, a charging interval of a task needs to be obtained first; for a new virtual machine, a charging interval of the virtual machine begins with the start time of the task, is not less than the execution time of the task, and should be an integer multiple of a charging period; for a virtual machine to which a task has been allocated previously, a charging interval newly added to the virtual machine begins with an end time of a previous charging interval, and should be an integer multiple of a charging period; and once the charging interval is obtained, the scheduling cost of the task may be calculated according to Formulas (1) and (2).

In one of the embodiments, to satisfy a resource constraint of the private cloud, it is essential to find a feasible virtual machine deployment solution; and according to the designed method, if a virtual machine is newly created, all available physical machines are used as candidates, and the virtual machine is deployed on any physical machine that can satisfy a resource requirement of the virtual machine.

In one of the embodiments, if a task has been allocated to the virtual machine previously, it indicates that the virtual machine has been previously deployed on a physical machine; and therefore, the following two cases need to be considered: once the deployed physical machine has sufficient resources, the virtual machine continues to be deployed on the physical machine; and otherwise, all other physical machines are used as candidates, and the virtual machine is deployed on any physical machine that can satisfy a resource requirement of the virtual machine.

In one of the embodiments, a method for continuously updating fireworks is specifically as follows: a group of sparks are generated first for each firework fw, where each spark is encoded and decoded by using the first method and the second method, to obtain a group of candidate solutions; the best spark is then determined, and once an objective value of a scheduling solution corresponding to the spark is lower than an objective value of the firework fw, fw is replaced; otherwise, an inferior solution is accepted according to a particular acceptance probability, to avoid trapping into a local optimum; and in a search process, a temperature variable in the Metropolis criterion gradually decreases as a cooling rate increases, to simulate that a probability of accepting a relatively poor solution slowly decreases as the number of iterations increases.

In one of the embodiments, the stop condition includes a maximum iteration time.

The invention also provides a computer device including a memory, a processor, and a computer program stored in the memory and configured to be executed by the processor, where the processor is configured to execute the program to implement the steps in any foregoing method.

The invention further provides a computer-readable storage medium storing a computer program thereon, where a processor is configured to execute the program to implement the steps in any foregoing method.

The invention further provides a processor which is configured to execute a program, where the program is executed to implement any foregoing method.

The beneficial effects of the present invention are as follows:

(1) A periodic charging mode widely used in cloud computing is considered in a formal model of the present invention. The model formally defines that the subscription duration of each virtual machine definitely satisfies an integer multiple of a charging period and defines a total cost calculation method based on a continuous use discount model, to help to precisely calculate a cost and appropriately increase the continuous use of resources to reduce the cost.

(2) The problem of virtual machine deployment is considered in the model of the present invention. Decision variables of virtual machine deployment are defined, and a resource constraint is formally described, so that a resource constraint in hybrid cloud may be described more precisely without reducing the flexibility of cloud resources, to help to accurately describe a search space. In addition, the present invention may further explicitly provide a virtual machine deployment solution, to assist a private cloud in configuring a physical resource thereof.

(3) The present invention provides an improved firework algorithm. The algorithm provides a new firework representation method, to satisfy dependence relationships among tasks in the service processes. In addition, a new firework decoding strategy is provided, so that in the present invention, a firework may be mapped to a feasible solution in which virtual machine deployment and a periodic charging mode are considered. Further, a new firework update strategy based on the Metropolis criterion is provided. The strategy avoids the deficiency that a conventional firework algorithm tends to be trapped into a local optimum, thereby improving the computing efficiency.

### BRIEF DESCRIPTION OF THE DRAWINGS

FIG. 1 is a schematic diagram of a method for scheduling of service processes in hybrid cloud considering virtual machine deployment and an interval-based charging mode according to the present invention.

FIG. 2(a) and FIG. 2(b) are respectively schematic diagrams of an objective value of a CyberShake workflow and an objective value of a Montage workflow at different numbers of tasks in a method for scheduling of service processes in hybrid cloud considering virtual machine deployment and an interval-based charging mode according to the present invention.

FIG. 3(a) and FIG. 3(b) are respectively schematic diagrams of an objective value of a CyberShake workflow and an objective value of a Montage workflow at different numbers of virtual machine types in a cloud in a method for scheduling of service processes in hybrid cloud considering virtual machine deployment and an interval-based charging mode according to the present invention.

FIG. 4(a) and FIG. 4(b) are respectively schematic diagrams of an objective value of a CyberShake workflow and an objective value of a Montage workflow of using different numbers of physical machines in a private cloud in a method for scheduling of service processes in hybrid cloud considering virtual machine deployment and an interval-based charging mode according to the present invention.

FIG. 5(a) and FIG. 5(b) are respectively schematic diagrams of an objective value of a CyberShake workflow and an objective value of a Montage workflow based on different periodic charging modes in a method for scheduling of service processes in hybrid cloud considering virtual machine deployment and an interval-based charging mode according to the present invention.

### DETAILED DESCRIPTION OF THE PREFERRED EMBODIMENTS

The present invention is further described below with reference to the accompanying drawings and specific embodiments, to enable a person skilled in the art to better understand and implement the present invention. However, the embodiments are not intended to limit the present invention.

Model of the problem of scheduling of service processes in hybrid cloud considering virtual machine deployment and an interval-based charging mode

An objective of the model is to minimize a total cost. It is considered that in a discount model, a charging duration of one virtual machine may cover a plurality of charging intervals (the intervals have different charging prices). Therefore, it is essential to first calculate the number of charging intervals covered by the charging duration, and then obtain the cost of each virtual machine, as shown in Formulas (1) and (2):

$$\begin{matrix}ck = {arg min}_{i \leq \vert BL \vert , {be}_{i} - ( {BIE}_{kq}^{v} - {BIS}_{kq}^{v} ) \geq 0} \{ {be}_{i} - ( {BEI}_{kq}^{v} - {BSI}_{kq}^{v} ) \} ; and & ( 1 ) \\ cos {t}_{kq}^{v} = {\sum }_{i = 0}^{ck - 1} {\int }_{{bs}_{i}}^{{be}_{i}} {f}_{i} ( t ) dt + {\int }_{{bs}_{ck}}^{{BEI}_{kq}^{v} - {BSI}_{kq}^{v}} {f}_{ck} ( t ) dt , & ( 2 )\end{matrix}$$

where

in Formula (1), charging duration BIE_{kq}^{v}-BIS_{kq}^{v} is calculated and is then compared with an end time be, of each part, to obtain the number ck of covered charging intervals; in Formula (2), the cost of each covered interval may be calculated, and finally summation is performed to obtain a total cost;

The following table provides symbols used in the present application and the meanings of the symbols:

| Symbol | Explanation |
|---|---|
| xᵢⱼ^{kvq} | Binary variable, where xᵢⱼ^{kvq} = 1 represents that a task tᵢⱼ is |
| | allocated to an instance q of a virtual machine type v provided |
| | by a cloud provider cpₖ. |
| y_{vq}^{p} | Binary variable, where y_{vq}^{p} = 1 represents that the instance q |
| | of the virtual machine type v provided by a private cloud |
| | is deployed on a physical machine p. |
| ztᵢⱼ^{s} | Binary variable, where ztᵢⱼ^{s} = 1 represents that the task tᵢⱼ is |
| | being run at a moment s. |
| zv_{kvq}^{s} | Binary variable, where zv_{kvq}^{s} = 1 represents that the instance q |
| | of the virtual machine type v of the cloud provider cpₖ is being |
| | run at the moment s. |
| vcpuᵥ | Number of CPUs required for the virtual machine type v of the |
| | private cloud. |
| vmemᵥ | Size of memory required for the virtual machine type v of the |
| | private cloud. |
| Cₚ^{cpu} | Number of CPUs provided by the physical machine p in the |
| | private cloud. |
| Cₚ^{mem} | Size of memory provided by the physical machine p in the |
| | private cloud. |
| saᵢⱼ | Start time of the task tᵢⱼ. |
| gᵢⱼ | Expected running time required for the task tᵢⱼ. |
| dt | Deadline of the service processes. |
| bcₖ^{v} | Charging cycle of the virtual machine type v of the cloud |
| | provider cpₖ. |
| ρₚ | CPU usage of the physical machine p. |
| BIZₖ^{v} | Charging duration set of the virtual machine type v provided by |
| | the cloud provider cpₖ, because each virtual machine type may |
| | subscribe to a plurality of instances, BIZₖ^{v} = {[BISₖ₁^{v}, BIEₖ₁^{v}], |
| | [BISₖ₂^{v}, BIEₖ₂^{v}], . . .}, where BIS_{kq}^{v} and BIE_{kq}^{v} respectively |
| | represent a start time and an end time of the instance q. |
| VMTₖ | A group of virtual machine types provided by the cloud provider |
| | cpₖ. |
| CPS | Hybrid cloud, where cp₁ is the private cloud, and ExCs = |
| | {cp₂, . . . , cpₙ} is a public cloud set. |
| TS | Task set. |
| PMS | Physical machine set of the private cloud. |
| BL | Number of price intervals. |
| bsⱼ | Start time of a j^{th} price interval. |
| Beⱼ | End time of the j^{th} price interval. |
| fⱼ(t) | Pricing function of the j^{th} price interval. |
| ck | Number of price intervals covered by a subscription time of a |
| | virtual machine. |
| cost_{kq}^{v} | Subscription cost of a q^{th} virtual machine of the type v of the |
| | cloud provider cpₖ. |
| TC | Total subscription cost. |

In summary, the model for scheduling of service processes in hybrid cloud provided in the present invention is defined as follows:

$$\begin{matrix}min TC = {\sum }_{{cp}_{k} ∈ CPS} {\sum }_{{vmt}_{k}^{v} ∈ {VMT}_{k}} {\sum }_{q = 1}^{\vert {BIZ}_{k}^{v} \vert} cos {t}_{kq}^{v} ; & ( 3 ) \\ st . {sa}_{ij} \geq max \{ {sa}_{iu} + {g}_{iu} \vert {t}_{iu} \to {t}_{ij} \} , ∀ {t}_{ij} , {t}_{iu} ∈ TS ; & ( 4 ) \\ max \{ {sa}_{ij} + {g}_{ij} \vert {t}_{ij} ∈ TS \} \leq dt ; & ( 5 ) \\ ( {BIE}_{kq}^{v} - {BIS}_{kq}^{v} ) mod ( {bc}_{k}^{v} ) = 0 , ∀ {cp}_{k} ∈ CPS ; {vmt}_{k}^{v} ∈ {VMT}_{k} ; q = 1 , … , \vert {BIZ}_{k}^{v} \vert ; & ( 6 ) \\ {\sum }_{{cp}_{k} ∈ CPS} {\sum }_{{vmt}_{k}^{v} ∈ {VMT}_{k}} {\sum }_{q = 1}^{\vert {BIZ}_{k}^{v} \vert} {x}_{ij}^{kvq} = 1 , ∀ {t}_{ij} ∈ TS ; & ( 7 ) \\ {zv}_{kvq}^{s} \geq {\sum }_{{t}_{ij} ∈ TS} {zt}_{ij}^{s} \times {x}_{ij}^{kvq} , ∀ {cp}_{k} ∈ CPS ; {vmt}_{k}^{v} ∈ {VMT}_{k} ; s = 1 , … , ∞ ; & ( 8 ) \\ {\sum }_{{vmt}_{1}^{v} ∈ {VMT}_{1}} {\sum }_{q = 1}^{\vert {BIZ}_{1}^{v} \vert} {ρ}_{p} \times {y}_{vq}^{p} \times {zv}_{1 vq}^{s} \times {vcpu}_{v} \leq {C}_{p}^{cpu} , ∀ s = 1 , … , ∞ ; {pm}_{p} ∈ PMS ; & ( 10 ) \\ {\sum }_{{vmt}_{1}^{v} ∈ {VMT}_{1}} {\sum }_{q = 1}^{\vert {BIZ}_{1}^{v} \vert} {y}_{vq}^{p} \times {zv}_{1 vq}^{s} \times {vmem}_{v} \leq {C}_{p}^{mem} , ∀ s = 1 , … , ∞ ; {pm}_{p} ∈ PMS ; & ( 11 ) \\ {zt}_{ij}^{s} = \{ \begin{matrix}1 & if s ∈ [ {sa}_{ij} , {sa}_{ij} + {g}_{ij} ] \\ , & \\ 0 & otherwise ;\end{matrix} & ( 12 ) \\ {zv}_{kvq}^{s} = \{ \begin{matrix}1 & if s ∈ [ {BSI}_{kq}^{v} , {BEI}_{kq}^{q} ] \\ , & \\ 0 & otherwise ;\end{matrix} & ( 13 ) \\ {x}_{ij}^{kvq} ∈ \{ 0 , 1 \} , ∀ {t}_{ij} ∈ TS ; {cp}_{k} ∈ CPS ; {vmt}_{k}^{v} ∈ {VMT}_{k} ; q = 1 , … , \vert {BIZ}_{k}^{v} \vert ; and & ( 14 ) \\ {y}_{vq}^{p} ∈ \{ 0 , 1 \} , ∀ {t}_{ij} ∈ TS ; {pm}_{p} ∈ PMS ; {vmt}_{1}^{v} ∈ {VMT}_{1} ; q = 1 , … , \vert {BIZ}_{1}^{v} \vert , & ( 15 )\end{matrix}$$

Objective (3) is to minimize the total cost for a user; Constraints (4) and (5) define the dependence relationships of tasks and the deadline constraint of the service processes in the cloud; Constraint (6) indicates that charging duration of a virtual machine is an integer multiple of a charging period; Constraint (7) represents that each task needs to be allocated to one virtual machine; Constraint (8) indicates that only one task can be run at one time on each virtual machine; Constraint (9) ensures that each virtual machine provided on a private cloud needs to be deployed on one physical machine; Constraints (10) and (11) ensure that CPU and memory requirements of each virtual machine provided on the private cloud do not exceed an available resource limitation of a physical machine deployed on the private cloud; and Formulas (12) to (15) provide the definitions of decision variables.

Solution seeking based on an improved firework algorithm

In view of the characteristics of a scheduling problem, the present invention provides an algorithm for scheduling of service processes in hybrid cloud based on an improved firework algorithm. A flowchart design of the algorithm is as follows.

Algorithm 1: Method for Representing Firework Encoding Considering Task Dependence Relationships

Firework encoding is usually defined as a real number list, but an encoding scheme of the real number list cannot be directly used for a scheduling problem. The real number list may further be converted into the priority list of tasks according to an ROV rule, where a task with a relatively low priority is first allocated to a resource. However, the foregoing method is only applicable to independent tasks. A method for representing firework encoding considering dependence relationships among tasks (an algorithm 1) is provided herein based on current researches. In the algorithm, one task is allocated to each position in an encoding list by using Formula (16). As shown in Formula (16), in the algorithm, it is relatively more likely to select a task with the highest priority, or a task is selected at a low probability based on roulette wheel selection, to improve diversity. In addition, a task needs to be chosen before a subsequent task of the task can be considered, to ensure that the priority of each task is definitely lower than a preceding task of the task.

$${t}_{ij} ( k ) = \{ \begin{matrix}{arg max}_{{t}_{ij} ∈ STP} \{ {fw}_{ij} \} , & if rand ( 0 , 1 ) \leq {p}_{0} \\ Rou ( \frac{{fw}_{ij}}{{\sum }_{{t}_{ij} ∈ STP} {fw}_{ij}} ) , & otherwise ,\end{matrix} \qquad ( 16 )$$

where tᵢⱼ(k) is a task allocated to a k^{th} position; STP is a set of arrangeable tasks; fwᵢⱼis a real number value corresponding to a task tᵢⱼ in firework encoding; p₀ is a preset threshold; rand(0, 1) is a decimal randomly generated in the interval (0, 1); and Rou(·) represents a roulette wheel selection strategy.

Algorithm 2: Allocation of a Task to a Virtual Machine in Consideration of a Resource Priority

To avoid the traversal of all virtual machines and increase the interval of continuous use, three resource priority principles are designed: 1. a principle of assigning a priority to a virtual machine to which a preceding task is allocated: in this case, because a virtual machine may continue to execute a current task and there is no idle wait time between tasks, an idle time caused by periodic charging can be fully utilized and the time of continuous use can be increased; 2. if the first case is not satisfied, a search interval is extended to all virtual machines to which a task has been allocated previously, and the case helps to increase the duration of continuous use of an existing virtual machine; and 3. if neither of the foregoing two cases is satisfied, all newly created virtual machine instances are considered, to ensure that a task is allocated to a feasible virtual machine.

In addition, after tasks are all arranged on virtual machines, a scheduling cost further needs to be calculated. For the characteristics of the periodic pricing mode, a cost calculation method based on the periodic pricing mode is designed, to precisely calculate a subscription cost of a specific virtual machine in the periodic pricing mode. In the method, a charging interval of a task needs to be obtained first. For a new virtual machine, a charging interval of the virtual machine begins with the start time of the task, is not less than the execution time of the task, and should be an integer multiple of a charging period. For a virtual machine to which a task has been allocated previously, a charging interval newly added to the virtual machine begins with an end time of a previous charging interval, and should be an integer multiple of a charging period. Once the charging interval is obtained, the scheduling cost of the task may be calculated according to Formulas (1) and (2).

Further, to satisfy a resource constraint of the private cloud, it is essential to find a feasible virtual machine deployment solution. According to the designed method, if a virtual machine is newly created, all available physical machines are used as candidates, and the virtual machine is deployed on any physical machine that can satisfy a resource requirement of the virtual machine. If a task has been allocated to the virtual machine previously, it indicates that the virtual machine has been previously deployed on a physical machine. Therefore, the following two cases need to be considered: once the deployed physical machine has sufficient resources, the virtual machine continues to be deployed on the device; and otherwise, all other physical machines are used as candidates, and the virtual machine is deployed on any physical machine that can satisfy a resource requirement of the virtual machine.

Algorithm 3: Firework Update Based on the Metropolis Criterion

To reduce the complexity of computation and avoid a local optimum, a firework update strategy based on the Metropolis criterion is designed. Specifically, a group of sparks are generated first for each firework fw, where each spark is encoded and decoded by using the algorithm 1 and the algorithm 2, to obtain a group of candidate solutions. The best spark is then determined, and once an objective value of a scheduling solution corresponding to the spark is lower than an objective value of the firework fw, fw is replaced. Otherwise, an inferior solution is accepted according to a particular acceptance probability, to avoid trapping into a local optimum. In a search process, a temperature variable in the Metropolis criterion gradually decreases as a cooling rate increases, to simulate that a probability of accepting a relatively poor solution slowly decreases as the number of iterations increases.

Algorithm 4: Algorithm for Scheduling of Service Processes in Hybrid Cloud Based on an Improved Firework Algorithm (FWAPS_VI)

In summary, the algorithm for scheduling of service processes in hybrid cloud based on an improved firework algorithm (FWAPS_VI) is shown in Algorithm 4. In an initial phase, an initial firework population is generated first. Random encoding is first performed on each firework into a real number list, represented by a priority list of tasks by using the algorithm 1. Next, each firework is decoded into a complete scheduling solution by invoking the algorithm 2, and an objective value of the solution is calculated. In an iteration phase, the firework is continuously updated by using the algorithm 3. Specifically, in each iteration, a group of candidate sparks are first generated, and the firework is then updated according to the Metropolis criterion. The best solution is outputted once a stop condition (for example, maximum iteration time) is satisfied.

Algorithm 4: Provided solution-seeking algorithm-FWAPS_VI

Input: a task set TS, a hybrid cloud CPS, a physical machine set PMS, a

periodic charging mode TCM, a maximum number of iterations Maxᵢₜₑᵣ, a group
population Gₚₒₚ, a maximum generation number E of sparks, a maximum explosion
amplitude R, an initial temperature T, and a cooling rate cr.

| Output: Best solution gbest. | | | |
|---|---|---|---|
| 1. | Initialize parameters and calculate a subdeadline of each task; | | |
| 2. | for i = 1 to Gₚₒₚ do /*initial phase*/ | | |
| 3. | \| | randomly generate an initial firework fw, and determine the priority of a | |
| | \| | task by using an algorithm 1; | |
| 4. | \| | decode the firework by using an algorithm 2, and calculate an objective | |
| | \| | value of the firework by using Formula (3); | |
| 5. | └ | Fireworks.add (fw); | |
| 6. | while a stop condition is not satisfied do /*iteration phase*/ | | |
| 7. | \| | \| | for each firework fw in Fireworks do |
| 8. | \| | \| | obtain an updated firework fw′ by using an algorithm 3; |
| 9. | \| | \| | Fireworks[fw].update (fw′); |
| 10. | \| | └ | update a temperature T = T × cr; |

| | | |
|---|---|---|
| 11. | └ | gbest = a solution with the smallest objective value in Fireworks |

| | |
|---|---|
| 12. | return gbest. |

One specific application scenario of the present invention is provided below:

Experimental Setting

In the present invention, instances of a CyberShake workflow and a Montage workflow that are built by using a workflow generator are used to estimate a provided algorithm. Each instance is represented by a DAX (a directed acyclic graph in XML) format (for example, CYBERSHAKE.n.50.xx.dax). Because each workflow with a specific number of tasks and a specific structure has 19 instances, one instance is randomly selected in each test case in the present invention.

The problem of scheduling of service processes in hybrid cloud based on periodic charging and virtual machine deployment is rarely fully considered in existing researches. Methods completely applicable to the problem are not found, and no results of the methods are compared with the result of the method in the present invention. Therefore, three methods that are provided most recently and are closest to the research content in the present invention are selected below in the present invention to compare algorithm performance.

EATSHC is an algorithm for scheduling of service processes in hybrid cloud based on pheromone, and a virtual resource pool constraint is defined in this algorithm. Because virtual machine deployment is not considered, the best solution found by using the algorithm may be unfeasible. To apply the algorithm to the research problem of the present invention, the best solution outputted by the algorithm needs to be processed as follows: The algorithm 2 is used to examine whether a virtual machine in a private cloud can be deployed on a physical machine. Once deployment fails, a task allocated on the virtual machine is outsourced to a virtual machine instance of a type with the lowest cost in a public cloud.

HGSA is a gravity-based algorithm for scheduling of service processes in public cloud considering a charging period, where some tasks may be allocated to the same virtual machine, to increase the duration of continuous use. Similarly, because the problem of virtual machine deployment is not considered, the best solution of the algorithm may be unfeasible. Therefore, the best solution outputted by the algorithm needs to be processed in the foregoing EATSHC manner.

HBLBA is a heuristic IaaS cloud load balancing algorithm. Both a mapping between a task and a virtual machine and virtual machine deployment are considered in the algorithm. However, no dependence tasks is considered in the method, and once physical resources are insufficient, a task is rejected. To ensure the dependence relationships among tasks, a priority list is randomly generated in each iteration, and the algorithm 1 is used to obtain the priority of a task. In addition, once a virtual machine in a private cloud cannot be deployed on one physical machine according to the algorithm 2, a task allocated on the virtual machine is outsourced to a virtual machine instance of a type with the lowest cost in a public cloud.

All methods are written using C# and are performed on a PC that uses a 64-bit Intel core i5 CPU with the operating system Windows 10 and 8-GB memory. The population of each algorithm is Gₚₒₚ=30. The parameters in the method of the present invention are E=50, R=1, T=10000, and cr=0.98. The parameters of other algorithms are set according to the original literature. The effectiveness of the algorithms is evaluated by using an objective value calculated in Formula (3). In addition, a composite termination condition is further used: execution is carried out at least the minimal number of iterations Miniter=500. When the number of unimproved iterations reaches unImpiter=200 or the number of iterations reaches Maxiter=10000, the algorithm stops. In addition, because of the randomness of the algorithm, each test case is independently run 20 times, to obtain an average objective value.

Result Analysis

It is considered that the complexity of the algorithm for scheduling of service processes in hybrid cloud is affected by the number of tasks, the number of virtual machines, and the number of physical machines in a private cloud. Therefore, three groups of test cases with different problem scales are designed in the present invention. In addition, to estimate the effectiveness of solution seeking of an algorithm for service processes scheduling problem in a periodic charging mode, a group of test cases including different charging periods and discounts are further designed.

(1) Test Cases with Different Numbers of Tasks

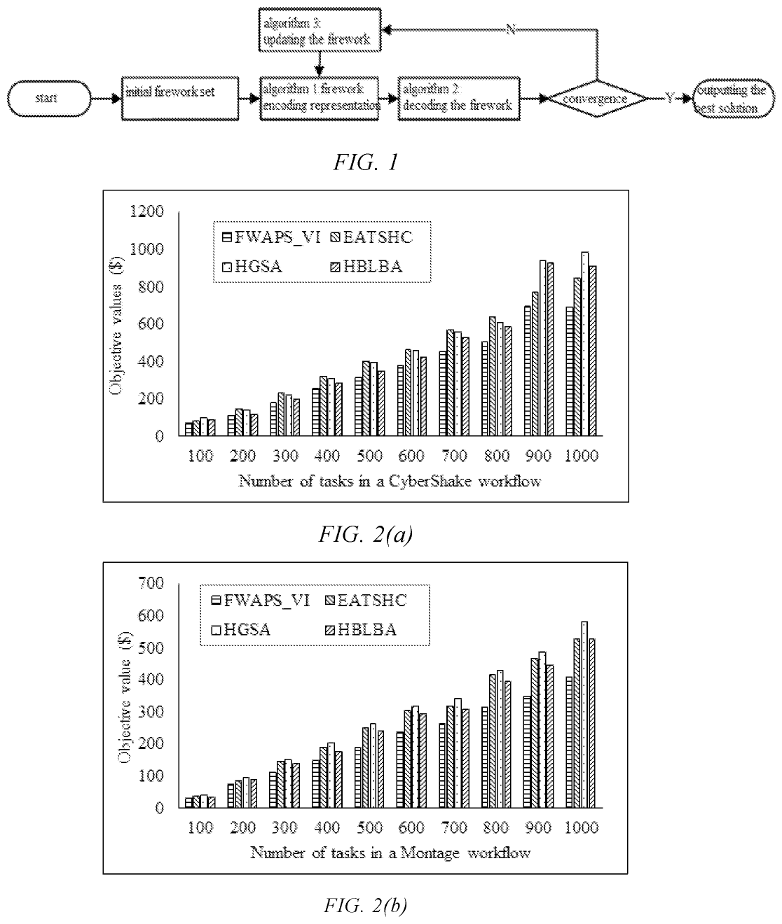

In this group of experiments, the number of tasks increases from 100 to 1000, and 100 is added each time. Each cloud provides three virtual machine types. Four physical machines are provided in a private cloud. The results are shown in FIG. 2.

As can be seen from FIG. 2, for a scheduling problem of the CyberShake workflow and the Montage workflow with different numbers of tasks, an objective value calculated by using an FWAPS_VI method in the present invention is minimal. FIG. 2(a) shows a test case for the CyberShake workflow. Compared with other algorithms, the cost reduction rate of this algorithm is 3.98% to 42.27%. (cost reduction rate %=(an average objective of comparison algorithms−an average objective of FWAPS_VI)/an average objective of FWAPS_VI). FIG. 2(b) shows a test case for the Montage workflow. Compared with other algorithms, the cost reduction rate of this algorithm is 41.88% to 10.53%.

(2) Test Cases with Different Numbers of Virtual Machine Types

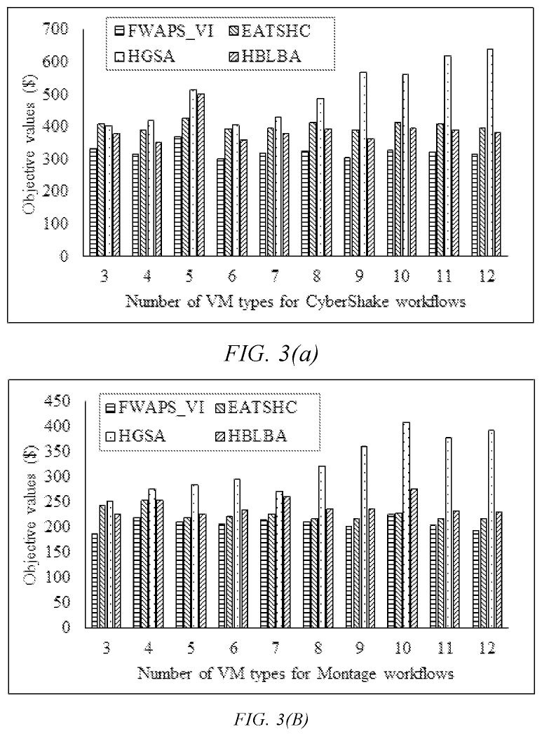

In this group of experiments, the number of virtual machine types provided in each cloud increases from 3 to 12, and one virtual machine type is added each time. The number of tasks is 500. Four physical machines are provided in a private cloud. The results are shown in FIG. 3.

As can be seen from FIG. 3, for a task scheduling problem of different numbers of virtual machine types, the FWAPS_VI method in the present invention may obtain a lower objective value than other algorithms. FIG. 3(a) shows a test case for the CyberShake workflow. Compared with other algorithms, the cost reduction rate of this algorithm is 11.24% to 102.13%. FIG. 3(b) shows a test case for the Montage workflow. Compared with other algorithms, the cost reduction rate of this algorithm is 1.04% to 102.36%.

(3) Test Cases with Different Numbers of Physical Machines in a Private Cloud

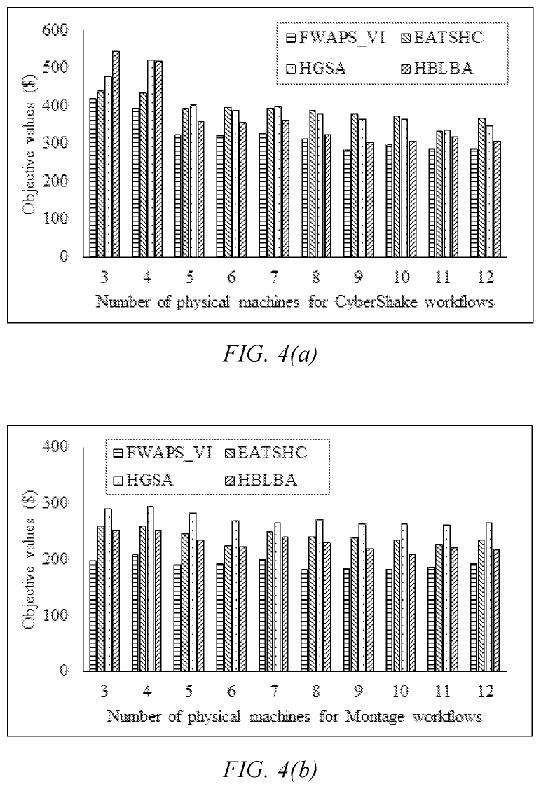

In this group of experiments, the number of physical machines in the private cloud increases from 3 to 12, and one physical machine is added each time. The number of tasks is 500. Each cloud provides three VM types. The results are shown in FIG. 4.

As can be seen from FIG. 4, in the FWAPS_VI method in the present invention, in a case that there are different numbers of physical machines in the private cloud, a lower objective value can be obtained as compared with other algorithms. FIG. 4(a) shows a test case for the CyberShake workflow. Compared with other algorithms, the cost reduction rate of this algorithm is 2.49% to 33.76%. FIG. 4(b) shows a test case for the Montage workflow. Compared with other algorithms, the cost reduction rate of this algorithm is 14.09% to 49.81%.

(4) Test Cases Based on Different Periodic Charging Modes

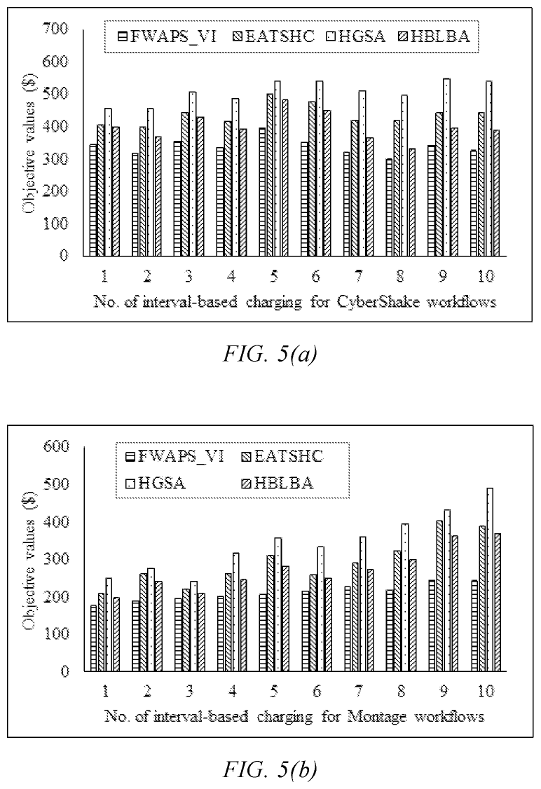

To fully estimate the performance of each service process scheduling algorithm in different periodic charging modes, 10 groups of test cases are designed in the present invention. A charging period of a test case increases from 0.5 h to 5 h, and 0.5 his added each time. The time of the duration of continuous use increases from 5 h to 14 h in each price section, and 1 h is added each time. The number of tasks is 500. Each cloud provides three virtual machine types. The results are shown in FIG. 5.

As can be seen from FIG. 5, in the FWAPS_VI method of the present invention, in different charging modes, a lower objective value can be obtained as compared with other algorithms. FIG. 5(a) shows a test case for the CyberShake workflow. Compared with other algorithms, the cost reduction rate of this algorithm is 10.37% to 64.82%. FIG. 5(b) shows a test case for the Montage workflow. Compared with other algorithms, the cost reduction rate of this algorithm is 6.95% to 100.85%.

In summary, in different problem scales, the FWAPS_VI method in the present invention can obtain a better computing effect compared with other algorithms. The cost reduction rate of the method is from 1.04% to 102.36%. The reason is that HGSA mainly depends on a gravity-based Meta-heuristic strategy. In three other algorithms, both a Meta-heuristic strategy and a problem-related heuristic strategy are used to optimize the task allocation for virtual machines. In particular, in the method of the present invention, the designed heuristic-based decoding strategy jointly considers cost calculation in virtual machine deployment and a periodic charging mode. In addition, a designed FWA-based Meta-heuristic method may control the number of firework explosions and amplitude to rapidly locate the area in which an adequate solution is located, and use the Metropolis criterion to escape from a local optimum, to achieve a better solution-seeking effect.

The foregoing embodiments are merely preferred embodiments used to fully illustrate the present invention, and the protection scope of the present invention is not limited thereto. Equivalent replacements or variations made by a person skilled in the art to the present invention all fall within the protection scope of the present invention. The protection scope of the present invention is as defined in the claims.

1. A method for scheduling of service processes in hybrid cloud considering virtual machine deployment and an interval-based charging mode, comprising:
acquiring a task set TS, a hybrid cloud CPS, a physical machine set PMS, a periodic charging mode TCM, a maximum number of iterations Maxᵢₜₑᵣ, a group population Gₚₒₚ, a maximum generation number E of sparks, a maximum explosion amplitude R, an initial temperature T, and a cooling rate cr;
in an initial phase, first generating an initial firework population;
first performing random encoding on each firework into a real number list, represented by a priority list of tasks; decoding each firework into a complete scheduling solution, and calculating an objective value of the solution; and in an iteration phase, continuously updating the firework, and outputting the best solution once a stop condition is satisfied,
wherein a scheduling result satisfies:
$$\begin{matrix}ck = {arg min}_{i \leq \vert BL \vert , {be}_{i} - ( {BIE}_{kq}^{v} - {BIS}_{kq}^{v} ) \geq 0} \{ {be}_{i} - ( {BEI}_{kq}^{v} - {BSI}_{kq}^{v} ) \} ; and & ( 1 ) \\ cos {t}_{kq}^{v} = {\sum }_{i = 0}^{ck - 1} {\int }_{{bs}_{i}}^{{be}_{i}} {f}_{i} ( t ) dt + {\int }_{{bs}_{ck}}^{{BEI}_{kq}^{v} - {BSI}_{kq}^{v}} {f}_{ck} ( t ) dt , & ( 2 )\end{matrix}$$
in Formula (1), charging duration BIE_{kq}^{v}-BIS_{kq}^{v} is calculated and is then compared with an end time be, of each part, to obtain the number ck of covered charging intervals;
in Formula (2), the cost of each covered interval may be calculated, and finally summation is performed to obtain a total cost;
$$\begin{matrix}min TC = {\sum }_{{cp}_{k} ∈ CPS} {\sum }_{{vmt}_{k}^{v} ∈ {VMT}_{k}} {\sum }_{q = 1}^{\vert {BIZ}_{k}^{v} \vert} cos {t}_{kq}^{v} ; & ( 3 ) \\ st . {sa}_{ij} \geq max \{ {sa}_{iu} + {g}_{iu} \vert {t}_{iu} \to {t}_{ij} \} , ∀ {t}_{ij} , {t}_{iu} ∈ TS ; & ( 4 ) \\ max \{ {sa}_{ij} + {g}_{ij} \vert {t}_{ij} ∈ TS \} \leq dt ; & ( 5 ) \\ ( {BIE}_{kq}^{v} - {BIS}_{kq}^{v} ) mod ( {bc}_{k}^{v} ) = 0 , ∀ {cp}_{k} ∈ CPS ; {vmt}_{k}^{v} ∈ {VMT}_{k} ; q = 1 , … , \vert {BIZ}_{k}^{v} \vert ; & ( 6 ) \\ {\sum }_{{cp}_{k} ∈ CPS} {\sum }_{{vmt}_{k}^{v} ∈ {VMT}_{k}} {\sum }_{q = 1}^{\vert {BIZ}_{k}^{v} \vert} {x}_{ij}^{kvq} = 1 , ∀ {t}_{ij} ∈ TS ; & ( 7 ) \\ {zv}_{kvq}^{s} \geq {\sum }_{{t}_{ij} ∈ TS} {zt}_{ij}^{s} \times {x}_{ij}^{kvq} , ∀ {cp}_{k} ∈ CPS ; {vmt}_{k}^{v} ∈ {VMT}_{k} ; s = 1 , … , ∞ ; & ( 8 ) \\ {\sum }_{{vmt}_{1}^{v} ∈ {VMT}_{1}} {\sum }_{q = 1}^{\vert {BIZ}_{1}^{v} \vert} {ρ}_{p} \times {y}_{vq}^{p} \times {zv}_{1 vq}^{s} \times {vcpu}_{v} \leq {C}_{p}^{cpu} , ∀ s = 1 , … , ∞ ; {pm}_{p} ∈ PMS ; & ( 10 ) \\ {\sum }_{{vmt}_{1}^{v} ∈ {VMT}_{1}} {\sum }_{q = 1}^{\vert {BIZ}_{1}^{v} \vert} {y}_{vq}^{p} \times {zv}_{1 vq}^{s} \times {vmem}_{v} \leq {C}_{p}^{mem} , ∀ s = 1 , … , ∞ ; {pm}_{p} ∈ PMS ; & ( 11 ) \\ {zt}_{ij}^{s} = \{ \begin{matrix}1 & if s ∈ [ {sa}_{ij} , {sa}_{ij} + {g}_{ij} ] \\ , & \\ 0 & otherwise ;\end{matrix} & ( 12 ) \\ {zv}_{kvq}^{s} = \{ \begin{matrix}1 & if s ∈ [ {BSI}_{kq}^{v} , {BEI}_{kq}^{q} ] \\ , & \\ 0 & otherwise ;\end{matrix} & ( 13 ) \\ {x}_{ij}^{kvq} ∈ \{ 0 , 1 \} , ∀ {t}_{ij} ∈ TS ; {cp}_{k} ∈ CPS ; {vmt}_{k}^{v} ∈ {VMT}_{k} ; q = 1 , … , \vert {BIZ}_{k}^{v} \vert ; and & ( 14 ) \\ {y}_{vq}^{p} ∈ \{ 0 , 1 \} , ∀ {t}_{ij} ∈ TS ; {pm}_{p} ∈ PMS ; {vmt}_{1}^{v} ∈ {VMT}_{1} ; q = 1 , … , \vert {BIZ}_{1}^{v} \vert ; & ( 15 )\end{matrix}$$
wherein objective (3) is to minimize the total cost for a user;
constraints (4) and (5) define the dependence relationships of tasks and the deadline constraint of the service processes in the cloud;
constraint (6) indicates that charging duration of a virtual machine is an integer multiple of a charging period;
constraint (7) represents that each task needs to be allocated to one virtual machine;
constraint (8) indicates that only one task can be run at one time on each virtual machine;
constraint (9) ensures that each virtual machine provided on a private cloud needs to be deployed on one physical machine;
constraints (10) and (11) ensure that CPU and memory requirements of each virtual machine provided on the private cloud do not exceed an available resource limitation of a physical machine deployed on the private cloud; and
Formulas (12) to (15) provide the definitions of decision variables;

| Symbol | Explanation |
|---|---|
| xᵢⱼ^{kvq} | Binary variable, wherein xᵢⱼ^{kvq} = 1 represents that a task tᵢⱼ is |
| | allocated to an instance q of a virtual machine type v provided |
| | by a cloud provider cpₖ; |
| y_{vq}^{p} | Binary variable, wherein y_{vq}^{p} = 1 represents that the instance q |
| | of the virtual machine type v provided by a private cloud |
| | is deployed on a physical machine p; |
| ztᵢⱼ^{s} | Binary variable, wherein ztᵢⱼ^{s} = 1 represents that the task tᵢⱼ is |
| | being run at a moment s; |
| zv_{kvq}^{s} | Binary variable, wherein zv_{kvq}^{s} = 1 represents that the instance q |
| | of the virtual machine type v of the cloud provider cpₖ is being |
| | run at the moment s; |
| vcpuᵥ | Number of CPUs required for the virtual machine type v of the |
| | private cloud; |
| vmemᵥ | Size of memory required for the virtual machine type v of the |
| | private cloud; |
| Cₚ^{cpu} | Number of CPUs provided by the physical machine p in the |
| | private cloud; |
| Cₚ^{mem} | Size of memory provided by the physical machine p in the |
| | private cloud; |
| saᵢⱼ | Start time of the task tᵢⱼ; |
| gᵢⱼ | Expected running time required for the task tᵢⱼ; |
| dt | Deadline of the service processes; |
| bcₖ^{v} | Charging cycle of the virtual machine type v of the cloud |
| | provider cpₖ; |
| ρₚ | CPU usage of the physical machine p; |
| BIZₖ^{v} | Charging duration set of the virtual machine type v provided by |
| | the cloud provider cpₖ, because each virtual machine type may |
| | subscribe to a plurality of instances, BIZₖ^{v} = {[BISₖ₁^{v}, BIEₖ₁^{v}], |
| | [BISₖ₂^{v}, BIEₖ₂^{v}], . . .}, wherein BIS_{kq}^{v} and BIE_{kq}^{v} respectively |
| | represent a start time and an end time of the instance q; |
| VMTₖ | A group of virtual machine types provided by the cloud provider |
| | cpₖ; |
| CPS | Hybrid cloud, wherein cp₁ is the private cloud, and ExCs = |
| | {cp₂, . . . , cpₙ} is a public cloud set; |
| TS | Task set; |
| PMS | Physical machine set of the private cloud; |
| BL | Number of price intervals; |
| bsⱼ | Start time of a j^{th} price interval; |
| Beⱼ | End time of the j^{th} price interval; |
| fⱼ(t) | Pricing function of the j^{th} price interval; |
| ck | Number of price intervals covered by a subscription time of a |
| | virtual machine; |
| cost_{kq}^{v} | Subscription cost of a q^{th} virtual machine of the type v of the |
| | cloud provider cpₖ; |
| TC | Total subscription cost. |

2. The method for scheduling of service processes in hybrid cloud considering virtual machine deployment and an interval-based charging mode according to claim 1, wherein the priority list of tasks is represented by using a first method and the first method is as follows:
firework encoding is usually defined as a real number list, but an encoding scheme of the real number list cannot be directly used for a scheduling problem; the real number list may further be converted into the priority list of tasks according to an ROV rule, wherein a task with a relatively low priority is first allocated to a resource; however, the foregoing method is only applicable to an independent task; a method for representing firework encoding considering a task dependence relationship (an algorithm 1) is provided herein based on current researches; in the algorithm, one task is allocated to each position in an encoding list by using Formula (16); as shown in Formula (16), in the algorithm, it is relatively more likely to select a task with the highest priority, or a task is selected at a low probability based on roulette wheel selection, to improve diversity; and a task needs to be chosen before a subsequent task of the task can be considered, to ensure that the priority of each task is definitely lower than a preceding task of the task;
$${t}_{ij} ( k ) = \{ \begin{matrix}{arg max}_{{t}_{ij} ∈ STP} \{ {fw}_{ij} \} , & if rand ( 0 , 1 ) \leq {p}_{0} \\ Rou ( \frac{{fw}_{ij}}{{\sum }_{{t}_{ij} ∈ STP} {fw}_{ij}} ) , & otherwise ,\end{matrix} \qquad ( 16 )$$
wherein tᵢⱼ(k) is a task allocated to a k^{th} position; STP is a set of tasks ready to be scheduled; fwᵢⱼ is a real number value corresponding to a task tᵢⱼ in firework encoding; p₀ is a preset threshold; rand(0, 1) is a decimal randomly generated in the interval (0, 1); and Rou(·) represents a roulette selection strategy.

3. The method for scheduling of service processes in hybrid cloud considering virtual machine deployment and an interval-based charging mode according to claim 1, wherein each firework is decoded into a complete scheduling solution by using a second method comprising:
designing three resource priority principles to avoid the traversal of all virtual machines and increase the interval of continuous use:
(1) a principle of assigning a priority to a virtual machine to which a preceding task is allocated: in this case, because a virtual machine may continue to execute a current task and there is no idle wait time between tasks, an idle time caused by periodic charging can be fully utilized and the time of continuous use can be increased;
(2) if the first case is not satisfied, a search interval is extended to all virtual machines to which a task has been allocated previously, and the case helps to increase the duration of continuous use of an existing virtual machine; and
(3) if neither of the foregoing two cases is satisfied, all newly created virtual machine instances are considered, to ensure that a task is allocated to a feasible virtual machine; and
after tasks are all arranged on virtual machines, a scheduling cost further needs to be calculated; a charging interval of a task needs to be obtained first; for a new virtual machine, a charging interval of the virtual machine begins with the start time of the task, is not less than the execution time of the task, and should be an integer multiple of a charging period; for a virtual machine to which a task has been allocated previously, a charging interval newly added to the virtual machine begins with an end time of a previous charging interval, and should be an integer multiple of a charging period; and once the charging interval is obtained, the scheduling cost of the task may be calculated according to Formulas (1) and (2).

4. The method for scheduling of service processes in hybrid cloud considering virtual machine deployment and an interval-based charging mode according to claim 1, wherein to satisfy a resource constraint of the private cloud, it is essential to find a feasible virtual machine deployment solution; and according to the designed method, if a virtual machine is newly created, all available physical machines are used as candidates, and the virtual machine is deployed on any physical machine that can satisfy a resource requirement of the virtual machine.

5. The method for scheduling of service processes in hybrid cloud considering virtual machine deployment and an interval-based charging mode according to claim 1, wherein if a task has been allocated to the virtual machine previously, it indicates that the virtual machine has been previously deployed on a physical machine; and the following two cases need to be considered: once the deployed physical machine has sufficient resources, the virtual machine continues to be deployed on the physical machine; and otherwise, all other physical machines are used as candidates, and the virtual machine is deployed on any physical machine that can satisfy a resource requirement of the virtual machine.

6. The method for scheduling of service processes in hybrid cloud considering virtual machine deployment and an interval-based charging mode according to claim 1, wherein continuously updating fireworks comprises generating a group of sparks first for each firework fw, wherein each spark is encoded and decoded by using the first method and the second method, to obtain a group of candidate solutions; then determining the best spark, wherein once an objective value of a scheduling solution corresponding to the spark is lower than an objective value of the firework fw, fw is replaced; otherwise, an inferior solution is accepted according to a particular acceptance probability, to avoid trapping into a local optimum; and wherein in a search process, a temperature variable in the Metropolis criterion gradually decreases as a cooling rate increases, to simulate that a probability of accepting a relatively poor solution slowly decreases as the number of iterations increases.

7. The method for scheduling of service processes in hybrid cloud considering virtual machine deployment and an interval-based charging mode according to claim 1, wherein the stop condition comprises a maximum iteration time.

8. A computer device, comprising a memory, a processor, and a computer program stored in the memory and configured to be executed by the processor, wherein the processor is configured to execute the program to implement the steps in the method according to claim 1.

9. A computer-readable storage medium, storing a computer program thereon, wherein a processor is configured to execute the program to implement the steps in the method according to claim 1.

10. A processor, configured to execute a program, wherein the program is executed to implement the method according to claim 1.
